(19) United States
(12) Patent Application Publication
(10) Pub. No.: US 2010/0076395 A1
(43) Pub. Date: Mar. 25, 2010

(54) ELECTRICALLY CONDUCTIVE CARTRIDGE OR CARTRIDGE HOLDER

(75) Inventors: Claus Urup Gjødesen, Copenhagen (DK); Henrik Groth Ludvigsen, Lynge (DK)

Correspondence Address: NOVO NORDISK, INC.;INTELLECTUAL PROPERTY DEPARTMENT, 100 COLLEGE ROAD WEST, PRINCETON, NJ, 08540, US

(73) Assignee: Novo Nordisk A/S, Bagsvaerd (DK)

(21) Appl. No.: 12/531,829

(22) PCT Filed: Mar. 14, 2008
(86) PCT No.: PCT/EP08/53095

§ 371 Date: Nov. 19, 2009

(30) Foreign Application Priority Data
Mar. 20, 2007 (EP) 07104486.1

(51) Int. Cl. A61J 1/16

(52) U.S. Cl. 604/403

(57) ABSTRACT

The present invention relates to a cartridge or a cartridge holder adapted to be used in connection with handheld medication delivery devices. In particular, the present invention relates to intermediately positioned cartridges or cartridge holders providing at least one electrical connection between electronics of a medication delivery device and an injection needle attached to the medication delivery device. The electrical connection(s) between the electronics and the injection needle may be of galvanic or capacitive nature, the latter being provided via medicament contained in the cartridge.

### FIELD OF THE INVENTION

The present invention relates to a cartridge or a cartridge holder adapted to be used in connection with handheld medication delivery devices. In particular, the present invention relates to intermediately positioned cartridges or cartridge holders providing at least one electrical connection between electronics of a medication delivery device and an injection needle attached to the medication delivery device. The electrical connection(s) between the electronics and the injection needle may be of galvanic or capacitive nature, the latter being provided via medicament contained in the cartridge.

### BACKGROUND OF THE INVENTION

Various reasons may require that an electrical connection between electronics of a handheld medication delivery device and its injection needle is provided. Among other possible reasons such electrical connection or connections may be required if a remaining amount of medicament in a medicament containing cartridge is to be determined, for example by capacitive means. Also, for users of medication delivery devices it may be difficult to determine when effective contact has been established between the injection needle and the body. Moreover, when using a handheld medication delivery device it may difficult for the user of the device to determine the exact position of the tip of the injection needle in the body—i.e. whether the injection needle by accident has entered a vein or entered muscular tissue. Thus, there may be many good reasons to provide an electrical connection between electronics of a medication delivery device and an injection needle attached to the medication delivery device.

Generally, various types of cartridges, cartridge holders or combinations thereof for medication delivery devices have been suggested over the years. A huge majority of the these cartridges, cartridge holders or combinations thereof are electrically isolating devices providing no electrical connections between rear and front ends of said cartridges, cartridge holders or combinations thereof. Other types of cartridges, cartridge holders or combinations thereof are metal-based containers/devices which are electrically conductive but, for obvious reasons, do not provide well-defined interference free electrical connections between the rear and front ends.

In the patent literature references such as for example US 2002/0020654, U.S. Pat. No. 5,954,700, US 2001/0034506 and US 2006/0118612 suggest various ways for electronic marking or electronic encoding of medication cartridges. Moreover, in U.S. Pat. No. 5,628,309 a stationary apparatus for measuring levels of medicaments in disposable syringes is suggested. However, none of the before-mentioned references is concerned with transportation of electrical signals between a rear end and a front end of a cartridge or a cartridge holder for medication delivery devices.

It is an object of the present invention to provide a cartridge, a cartridge holder or a combination thereof for medication delivery devices, said cartridge, cartridge holder or the combination thereof providing one or more electrical connections between a rear end and a front end of said cartridge, cartridge holder or combination thereof.

It is a further object of the present invention to provide a cartridge, a cartridge holder or a combination thereof having an electrically isolating exterior body surface, the one or more electrical connections between the rear end and the front end of said cartridge, cartridge holder or combination thereof being embedded into said body.

### SUMMARY OF THE INVENTION

The above-mentioned objects are complied with by providing, in a first aspect, a cartridge holder adapted to form a lower part of a handheld medication delivery device when attached thereto, the cartridge holder comprising
a body extending from a rear end to a needle receiving portion of the cartridge holder, wherein the rear end of the cartridge holder comprises one or more electrical contacts arranged to provide electrical contact to corresponding electrical contacts arranged on an associated upper part of the medication delivery device to which the rear end of the cartridge holder is adapted to be attached, and wherein the needle receiving portion is adapted to establish a galvanic or capacitive connection to an electrically conductive exterior surface part of an injection needle attached to the cartridge holder, and
an electrically conductive element providing at least one electrical connection between the one or more electrical contacts at the rear end and the needle receiving portion,
   wherein the body of the cartridge holder comprises, between the rear end and the needle receiving portion, an exterior surface portion being galvanically isolated from the electrically conductive element and so disposed that the electrically conductive element is inaccessible from the exterior when the associated upper part of the medication delivery device and the injection needle are attached to the cartridge holder.

The cartridge holder may at its front end comprise a portion of reduced dimensions (cross-sectional dimensions) so as to retain a cartridge at the front end of the cartridge holder. Preferably, the electrically conductive element extends into the portion of reduced dimensions.

The medication delivery device of which the cartridge holder forms a lower part may be a pen-like medication delivery device.

The electrically conductive element may comprise an electrically conductive wire or electrically conductive two-dimensional mask or grid embedded into a sidewall portion of the body of the cartridge holder. The electrical conductive element may alternatively be formed by a polymer compound mix such as a mix of polypropylene and carbon nano-tubes.

Alternatively, the cartridge holder may comprise two materials arranged in a concentric manner relative to each other. Thus, an electrically conductive material may be provided as an inner material whereas an electrically isolating material may be provided as an outer material except in the end regions of the cartridge holder where the electrically conductive material must be electrically accessible from the outside. The electrically isolating material may form the exterior surface portion being galvanically isolated from the electrically conductive element.

In case of an embedded wire, the body of the cartridge holder may be made of a polymer-based material, such as plastic.

The cartridge holder may further comprise attachment means for attaching the cartridge holder to the associated upper part of the medication delivery device.

In a second aspect, the present invention relates to a cartridge for a medication delivery device, the cartridge being adapted to contain medicament to be expelled from said medication delivery device, the cartridge comprising a body having attachment means arranged on a rear end thereof for coupling the cartridge to the medication delivery device, said body extending from said rear end to a cartridge neck adapted to hold a septum piercable by an injection needle, wherein the body of the cartridge comprises an integrated electrically conductive element providing at least one electrical connection between the rear end of the cartridge and the cartridge neck, and wherein the body of the cartridge comprises, between the rear end and cartridge neck, an exterior surface portion being galvanically isolated from the electrically conductive element and so disposed that the electrically conductive element becomes inaccessible from the exterior when the cartridge forms part of a medication delivery device and when an injection needle pierces the septum.

At least part of the cartridge neck may have reduced outer dimensions (cross-sectional dimensions) compared to the rear end of the cartridge. Preferably, the electrically conductive element extends into the cartridge neck of reduced outer dimensions.

Again, the integrated electrically conductive element may comprise an electrically conductive wire or electrically conductive two-dimensional mask or grid embedded into a sidewall portion of the body of the cartridge. The electrical conductive element may alternatively be formed by a polymer compound mix such as a mix of polypropylene and carbon nano-tubes.

Alternatively, the integrated electrically conductive element may comprise an inner layer of an electrically conductive material, said inner layer being concentrically arranged with an electrically isolating outer layer forming the exterior surface portion being galvanically isolated from the electrically conductive element.

The body of the cartridge may be made of a polymer-based material, such as plastic.

The rear end of the cartridge may further comprise fastening means for releasably coupling the cartridge to corresponding fastening means of the medication delivery device.

Also, the external surface of the cartridge holder according to the first aspect and the cartridge according to the second aspect may be formed by an electrically conductive material wherein the surface material is galvanically isolated from the electrically conductive element. Such surface material may be adapted to form a shield for shielding the internal components against externally applied electromagnetic fields.

In a third aspect, the present invention relates to a medication delivery device comprising a cartridge holder according to the first aspect. In a fourth aspect, the present invention relates to a medication delivery device comprising a cartridge according to the second aspect.

In a fifth aspect, the present invention relates to a needle assembly for releasably coupling to a cartridge holding injection or infusion device where the needle assembly comprises an injection needle mounted in a needle hub. The assembly further comprises a first needle portion adapted to penetrate a cartridge seal and a second needle portion adapted to be inserted into dermis. The injection needle is made of an electrical conductive material, such as steel. The needle hub is at least partly made of an electrical conductive polymer, wherein said conductive polymer is disposed between a rim portion of the hub and the central portion contacting the injection needle. The polymeric conductive material may be disposed uniformly in the entire needle hub construction, or disposed internally or externally on the needle hub. Furthermore, the conductive material may be disposed as one or more narrow bands extending from the rim portion of the hub to the central part.

The rim portion of the hub may be adapted to electrically couple to electrical contact points disposed on a cartridge holder or to a cartridge having electrical contact points disposed on a surface part. Alternatively the rim portion may be adapted to couple directly to a medical delivery device portion holding electronic circuitry for electrically connectivity with the needle. In case the needle hub is mounted to a cartridge by means of an intermediary adaptor top, the adaptor top may comprise an electrical conductive portion for further connecting to electrical conductive elements disposed on the remaining portion of the cartridge or alternatively for further connecting to electrical contact points disposed on the cartridge holder.

The electrical conductive portion of the needle hub may be formed by a polymer compound mix such as a mix of polypropylene and carbon nano-tubes. The electrical conductive portion may be established by using a special 2K moulding technique or by applying a conductive coating to the process. Further, the injection needle may be attached to the needle hub by means of an electrical conductive glue.

### BRIEF DESCRIPTION OF THE INVENTION

The present invention will now be described in further details with reference to the accompanying figures, wherein

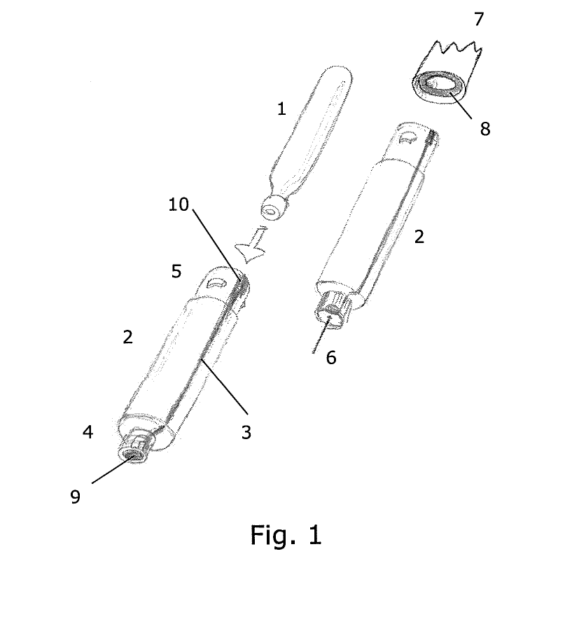

FIG. 1 illustrates a cartridge and a cartridge holder for a medication delivery device,

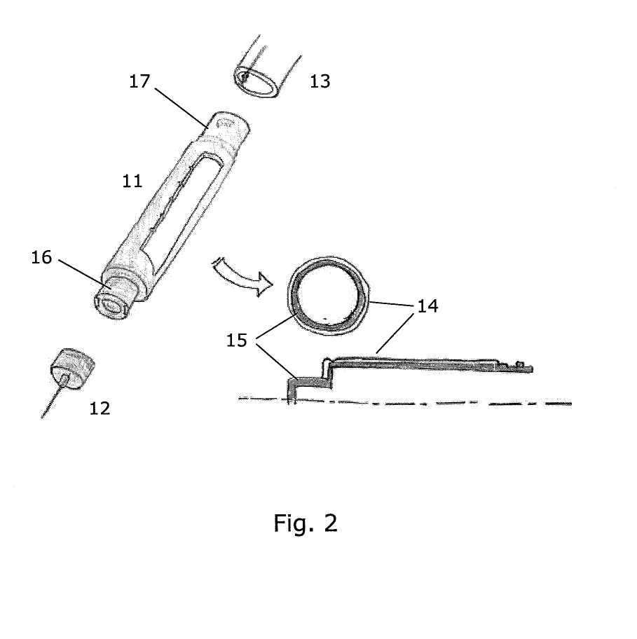

FIG. 2 shows a cartridge holder according to the present invention, and

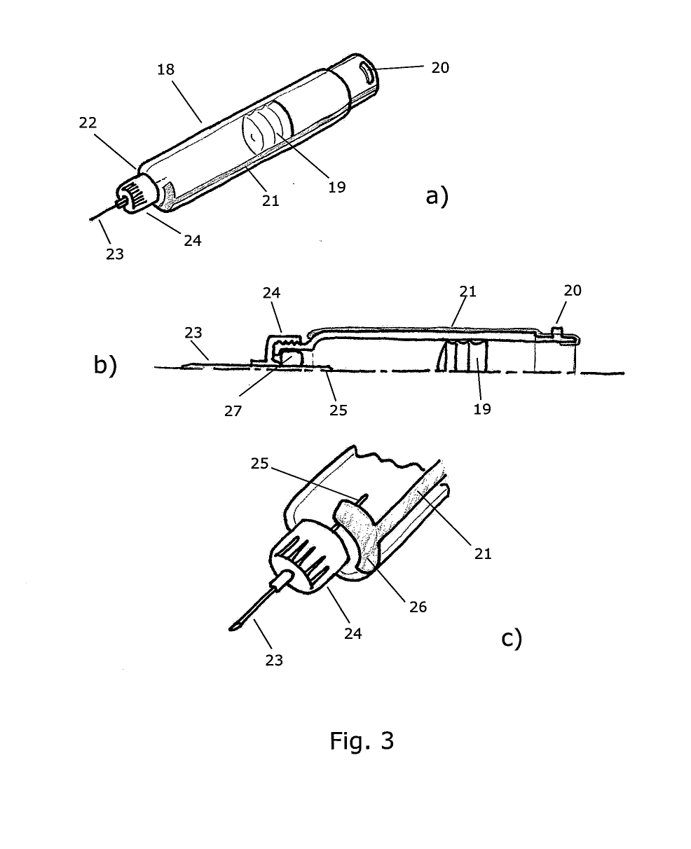

FIG. 3 shows a cartridge according to an embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE INVENTION

In its broadest concept the present invention relates to a cartridge or a cartridge holder having an integrated electrically conductive element and an outer surface which is galvanically isolated from the electrically conductive element. The integrated electrically conductive element, such as for example an embedded electrically conductive wire, mask or grid, provides at least one electrical connection between a rear end of the cartridge or cartridge holder and a front end of the cartridge or cartridge holder.

In case of a cartridge holder electrical terminals may be provided near the rear end of the cartridge holder. These terminals are adapted to electrically connect to corresponding terminals of a medication delivery device thereby establishing electrical connections from the cartridge holder to the electronics of the medication delivery device. At the front end of the cartridge holder a needle receiving portion is arranged. The needle receiving portion is, preferably, adapted to detachably retain an injection needle in a fixed position relative to the medication delivery device. The needle receiving portion can provide a galvanic connection to an electrically conductive exterior surface portion of the injection needle, or it can provide means, such as appropriately positioned electrodes, for establishing a capacitive coupling between said electrodes and the exterior surface portion of the injection needle. Such capacitive coupling is provided via a medicament contained in a cartridge positioned in the cartridge holder. Thus, a cartridge containing an electrically conductive medicament needs to be positioned in the cartridge holder in order to establish the before-mentioned capacitive coupling. Furthermore, an injection needle having a back end penetrating a septum of the cartridge and thereby entering the medicament within the cartridge needs to be attached to the needle receiving portion of the cartridge holder.

Thus, by providing a cartridge holder as described above the electronics of the medication delivery device can be electrically connected to an injection needle attached to the medication delivery device.

In case of a cartridge electrical terminals may be provided near the rear end of the cartridge. These terminals are adapted to electrically connect to corresponding terminals of a cartridge holder into which the cartridge is adapted to be inserted. The cartridge holder provides the necessary electrical contact to the medication delivery device thereby establishing electrical connections from the cartridge to the electronics of the medication delivery device.

At the front end of the cartridge an injection needle is adapted to pierce a septum arranged at the cartridge neck. The injection needle is kept in position by a needle receiving portion of the cartridge holder into which of the cartridge has been inserted. The needle receiving portion of the cartridge holder is, preferably, adapted to detachably retain an injection needle in a fixed position relative to the medication delivery device. Near the cartridge neck of the cartridge electrodes are arranged to provide electrical contact to the needle receiving portion which can provide a galvanic connection to an electrically conductive exterior surface portion of the injection needle, Alternatively, said electrodes near the cartridge neck can, if appropriately positioned, establish a capacitive coupling between said electrodes and the exterior surface portion of the injection needle. Such capacitive coupling is provided via a medicament contained in the cartridge. An injection needle having a back end penetrating the septum of the cartridge and thereby entering the medicament within the cartridge needs to be attached to the needle receiving portion of the cartridge holder.

An electrically conductive wire, mask or grid can be embedded into the body of the cartridge between the rear end and the front end. Alternatively, an electrically conductive element may be formed as a polymer compound mix such as a mix of polypropylene and carbon nano-tubes.

Thus, by providing a cartridge as described above the electronics of the medication delivery device can be electrically connected to an injection needle attached to the medication delivery device.

Referring now to FIG. 1 the elements forming a handheld medication delivery device is depicted. As seen in FIG. 1 a medicament containing cartridge 1 is adapted to be inserted into a cartridge holder 2. The cartridge holder comprises a rear end 5 and a front end 4, the latter comprising a needle receiving portion adapted to detachably retain an injection needle 6 in a fixed position relative to the medication delivery device. As depicted in FIG. 1 an electrically conductive element 3 is provided between the rear end 5 and the front end 4 of the cartridge holder 2. By attaching the cartridge holder 2 to the upper part 7 of the medication delivery device one or more electrical connections can be established between electronics arranged in the upper part 7 of the medication delivery device and the injection needle 6. This/these electrical connection(s) is/are, as depicted in FIG. 1, provided via the cartridge holder 2. As depicted in the drawing, the rear end 5 of the cartridge holder 2 further comprises fastening means for releasably coupling the cartridge holder to corresponding fastening means of the upper part 7.

The electrical connection illustrated in FIG. 1 is a galvanic connection in that terminal 10 of the cartridge holder connects galvanically to terminal 8 of the upper part 7 of the medication delivery device. At the other end of the cartridge a back end (not shown) of the injection needle 6 galvanically connects to a connector pad 9 at the front end of the cartridge holder. In this way, a galvanic connection is established between the electronics of the upper part 7 of the medication delivery device and the injection needle 6.

Alternatively, the electrical connection may be provided via a capacitive coupling to the medicament in the cartridge near the injection needle. Thus, according to this embodiment a galvanic connection is still provided at the rear end 5 of the cartridge holder. However, near a front end of the cartridge 1 a capacitive coupling is established to a medicament in the cartridge. Since a back end of an injection needle is in electrical contact with the medicament the capacitive coupling to the medicament yields a connection to the injection needle. In this way, an electrical connection is established between the electronics of the upper part 7 of the medication delivery device and the injection needle 6.

The electrically conductive element 3 depicted in FIG. 1 is not accessible from the exterior between the rear end 5 and the front end 4. Thus, between the rear and front ends the exterior surface of the cartridge holder is constituted by a portion being electrically isolated from the electrically conductive element 3. This means that the electrically conductive element 3 is either embedded into the cartridge holder, or alternatively, the electrically conductive element 3 is provided along an inner surface of the cartridge holder.

In FIG. 2 a cartridge holder 11 is molded in a two component material 14, 15 where one material 14 is an electrical isolator whereas the other material 15 is an electrical conductor. The material 15 may be formed as a polymer compound mix such as a mix of polypropylene and carbon nano-tubes. In the end regions 16, 17 where electrical connections are to be established to the injection needle 12 and an upper part 13 of the medication delivery device, respectively, the electrically conductive material 15 is uncovered and thereby externally accessible. However, at the cartridge holder body 11, i.e. between end regions 16, 17, the electrically isolating material 14 covers or encapsulates the electrically conductive material 15. An injection needle 12 is attached to the front end 16 of the cartridge holder.

As mentioned in connection with FIG. 1 the electrically conductive element between the electronics contained in the upper part 13 of the medication delivery device and the injection needle 12 may be constituted by a galvanic connection, or it may involve a capacitive coupling to the medicament in the cartridge.

The cartridge holder body 11 may be so configured to securely retain a medication cartridge within the cartridge holder, so that the cartridge is embedded irremovably from the cartridge holder. In such case, the cartridge holder and cartridge sub-assembly forms a disposable cartridge.

Referring to FIGS. 1 and 2 the depicted upper parts 7, 13 of the medication delivery device comprises, in addition to the above-mentioned electronics, drive mechanism for expelling set dosages of medicament from the medication delivery device. Such drive mechanism typically involves a piston rod adapted to displace a displaceable piston in the cartridge. The upper parts 7, 13 may further comprise some sort of dose setting mechanism by which an amount of medicament to be expelled can be set. The required force for expelling a set dose of medicament can be fully provided by the user of the device during expelling. Alternatively, the user of the device may energize a resilient member, such as a linear spring or a torsion spring, said accumulated energy being released during expelling a set dose of medicament.

Referring now to FIG. 3a a cartridge according to an embodiment of the present invention is depicted. The cartridge shown in FIG. 3 has a body of an electrically isolating material. At the rear end of the cartridge attachment means 20 are provided. The attachment means 20 allow that the cartridge can be attached to some sort of drive mechanism, such as for example an upper part of a pen-shaped medication delivery device or to a miniature pump. As depicted in FIG. 3a a displaceable piston 19 is provided within the cartridge. When medicament contained in the cartridge is to be expelled from the cartridge said piston is moved in the direction of the cartridge neck 22 which is provided opposite to the rear end of the cartridge. The cartridge neck 22 has reduced outer dimensions compared to the outer dimensions of the remaining body of the cartridge. The reduced outer dimensions of the cartridge neck 22 allows that an injection needle 23 mounted in a hub 24 can be attached to the cartridge. An electrically conductive element 21 is provided in the longitudinal direction of the cartridge. The electrically conductive element provides at least one electrical connection between the rear end of the cartridge and the cartridge neck.

An enlarged version of the cartridge neck is depicted in FIG. 3c. As seen in FIG. 3c the electrically conductive element 21 forms an electrode 26 in the cartridge neck zone. This allows that signals provided to the electrically conductive element 21 can be capacitively coupled to a back end 25 of the injection needle via said electrode 26. Thus, if the electrically conductive element extends into the cartridge neck and thereby forms a spatial overlap with the back end 25 of the injection needle electrical signals can coupled capacitively from the electrically conductive element 21 to the injection needle 23,25.

A cross-sectional view of the cartridge is shown in FIG. 3b. In addition to the features disclosed in connection with FIGS. 3a and 3c a piercable septum 27 is depicted in FIG. 3b. The piercable septum 27 is penetrated by the back end 25 of the injection needle when an injection needle is attached to the cartridge.

Preferably, the cartridge shown in FIG. 3a-c has an exterior surface portion (not shown in FIG. 3) being galvanically isolated from the electrically conductive element. The exterior surface portion is disposed in such a way that the electrically conductive element becomes electrically inaccessible from the exterior when the cartridge forms part of a medication delivery device and when an injection needle pierces the septum. By providing such an exterior surface portion the electrically conductive element is mechanically protected. Moreover, an accidental electrical connection to the electrically conductive element is avoided.

1. A cartridge holder adapted to form a lower part of a handheld medication delivery device when attached thereto, the cartridge holder comprising
a body extending from a rear end to a needle receiving portion of the cartridge holder, wherein the rear end of the cartridge holder comprises one or more electrical contacts arranged to provide electrical contact to corresponding electrical contacts arranged on an associated upper part of the medication delivery device to which the rear end of the cartridge holder is adapted to be attached, and wherein the needle receiving portion is adapted to establish a galvanic or capacitive connection to an electrically conductive exterior surface part of an injection needle attached to the cartridge holder, and
an electrically conductive element providing at least one electrical connection between the one or more electrical contacts at the rear end and the needle receiving portion,
wherein the body of the cartridge holder comprises, between the rear end and the needle receiving portion, an exterior surface portion being galvanically isolated from the electrically conductive element and so disposed that the electrically conductive element is inaccessible from the exterior when the associated upper part of the medication delivery device and the injection needle are attached to the cartridge holder.

2. A cartridge holder according to claim 1, wherein the cartridge holder at its front end comprises a portion of reduced dimensions so as to retain a cartridge at the front end of the cartridge holder and where the electrically conductive element extends into the portion of reduced dimensions.

3. A cartridge holder according to claim 1, wherein the body of the cartridge holder is made of a polymer-based material, such as plastic.

4. A cartridge holder according to claim 1, wherein the electrically conductive element comprises an electrically conductive wire, mask or grid embedded into a sidewall portion of the body of the cartridge holder.

5. A cartridge holder according to claim 1, wherein the electrically conductive element comprises an inner layer of an electrically conductive material, said inner layer being concentrically arranged with the electrically isolating outer layer.

6. A cartridge holder according to claim 1, further comprising attachment means for attaching the cartridge holder to the associated upper part of the medication delivery device.

7. A cartridge for a medication delivery device, the cartridge being adapted to contain medicament to be expelled from said medication delivery device, the cartridge comprising a body having attachment means arranged on a rear end thereof for coupling the cartridge to the medication delivery device, said body extending from said rear end to a cartridge neck adapted to hold a septum piercable by an injection needle, wherein the body of the cartridge comprises an integrated electrically conductive element providing at least one electrical connection between the rear end of the cartridge and the cartridge neck, and wherein the body of the cartridge comprises, between the rear end and cartridge neck, an exterior surface portion being galvanically isolated from the electrically conductive element and so disposed that the electrically conductive element becomes inaccessible from the exterior when the cartridge forms part of a medication delivery device and when an injection needle pierces the septum.

8. A cartridge according to claim 7, wherein at least part of the cartridge neck has reduced outer dimensions compared to the rear end of the cartridge, and wherein the electrically conductive element extends into the cartridge neck of reduced outer dimensions.

9. A cartridge according to claim 7, wherein the body of the cartridge is made of a polymer-based material, such as plastic.

10. A cartridge according to claim 7, wherein the integrated electrically conductive element comprises an electrically conductive wire, mask or grid embedded into a sidewall portion of the body of the cartridge.

11. A cartridge according to claim 7, wherein the integrated electrically conductive element comprises an inner layer of an electrically conductive material, said inner layer being concentrically arranged with an electrically isolating outer layer.

12. A medication delivery device comprising a cartridge holder according to claim 1.

13. A medication delivery device comprising a cartridge according to claim 7.
